(19) United States
(12) Patent Application Publication
(10) Pub. No.: US 2016/0372234 A1
(43) Pub. Date: Dec. 22, 2016

(54) INSULATED WIRE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Tsuyoshi NONAKA, Yokkaichi, Mie (JP)

(73) Assignees: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(21) Appl. No.: 15/102,650

(22) PCT Filed: Nov. 20, 2014
(86) PCT No.: PCT/JP2014/080730

§ 371 Date: Jun. 8, 2016

(30) Foreign Application Priority Data
Dec. 11, 2013 (JP) 2013255622

(51) Int. Cl. H01B 7/29; H01B 3/46; C08G 77/00; C09D 183/00; C09D 5/18; H01B 3/28; H01B 3/08

(52) U.S. Cl. CPC H01B 7/292; H01B 3/28; H01B 3/46; H01B 3/08; C09D 183/00; C09D 5/18; C08G 77/80; C08K 3/36

(57) ABSTRACT

An insulated wire that includes an insulating layer containing crosslinked silicone rubber and that has good heat resistance is provided. The insulated wire is obtained by covering a conductor with an insulating layer containing crosslinked silicone rubber and silica. The insulating layer contains the silica in an amount of not more than 40 mol % in terms of Si with respect to the total amount of the crosslinked silicone rubber and the silica. The crosslinked silicone rubber contains, in an amount of at least 0.5 mol %, a siloxane unit having a phenyl group as an organo group.

### TECHNICAL FIELD

The present invention relates to an insulated wire, and more specifically to an insulated wire to be preferably used in a vehicle such as an automobile.

### BACKGROUND ART

As insulating materials for insulated wires to be used in vehicles such as automobiles, materials containing halogen, such as polyvinyl chloride resins and compounds into which a halogen flame retardant is blended, are used. When the insulating materials containing halogen are disposed of by being incinerated, corrosive gas is generated in some cases. Therefore, from the viewpoint of environmental protection and the like, attempts have been made to use insulating materials containing no halogen.

Patent Document 1 states that a non-halogen insulating material obtained by blending aluminum hydroxide with crosslinked silicone rubber is used as the insulating material for an insulated wire, for example.

### CITATION LIST

### Patent Document

Patent Document 1: Japanese Patent No. 3555101

### SUMMARY OF INVENTION

### Technical Problem

However, a conventional insulated wire that includes an insulating layer containing crosslinked silicone rubber has poor heat resistance.

The problem to be solved of the present invention is to provide an insulated wire that includes an insulating layer containing crosslinked silicone rubber and that has good heat resistance.

### Solution to Problem

In order to solve the foregoing problems, an insulated wire according to the present invention is an insulated wire, wherein a conductor is covered with an insulating layer containing crosslinked silicone rubber and silica, the insulating layer containing the silica in an amount of not more than 40 mol % in terms of Si with respect to the total amount of the crosslinked silicone rubber and the silica, the crosslinked silicone rubber containing, in an amount of at least 0.5 mol %, a siloxane unit having a phenyl group as an organo group.

### Advantageous Effects of the Invention

With the insulated wire according to the present invention, the insulating layer contains silica in an amount of not more than 40 mol % in terms of Si with respect to the total amount of the crosslinked silicone rubber and the silica, the crosslinked silicone rubber contains, in an amount of at least 0.5 mol %, a siloxane unit having a phenyl group as an organo group, and thus good heat resistance is obtained.

### DESCRIPTION OF EMBODIMENTS

Next, an embodiment of the present invention will be described in detail.

An insulated wire according to the present invention includes a conductor and an insulating layer that covers the conductor. The insulating layer contains crosslinked silicone rubber and silica.

Blending silica can improve the heat resistance of the insulating layer containing the crosslinked silicone rubber. However, when the content of the silica is excessively large, the composition containing the crosslinked silicone rubber becomes excessively hard. This impairs the handleability, thus making it difficult to form the insulating layer. Moreover, the harder the insulating layer, the smaller the initial elongation of the insulating layer. If the initial elongation is smaller, the insulating layer to which a heat history has been provided has difficulty in satisfying the requirements for elongation of an insulating layer. That is, the heat resistance decreases. Therefore, the content of the silica is set to not more than 40 mol % in terms of Si with respect to the total content of the crosslinked silicone rubber and the silica.

On the other hand, from the viewpoint of improving the heat resistance of the insulating layer containing the crosslinked silicone rubber, for example, the content of the silica is preferably at least 3 mol %, and more preferably at least 5 mol %, in terms of Si with respect to the total content of the crosslinked silicone rubber and the silica.

The content of the silica and the content of the crosslinked silicone rubber with respect to the total content of the crosslinked silicone rubber and the silica can be analyzed using a solid state NMR.

The crosslinked silicone rubber includes silicone rubber having a siloxane chain structure. The silicone rubber having a siloxane chain structure can be obtained by performing dehydration condensation (condensation polymerization) of organosilanol that is obtained by hydrolyzing organochlorosilane in which chlorine and an organic group bond to silicon. When only organodichlorosilane, which includes two chloro groups, is used, chain silicone rubber is obtained. The crosslinked silicone rubber (silicone rubber having a netlike space) is obtained by crosslinking the chain silicone rubber with a method such as peroxide crosslinking, sulfur crosslinking, or hydrosilyl crosslinking. When organochlorosilane whose portion or entirety is constituted by organotrichlorosilane, which includes three chloro groups, is used, the crosslinked silicone rubber can be obtained without performing the above-mentioned crosslinking. Although the crosslinked silicone rubber may be obtained by any method as long as the crosslinked silicone rubber can be molded as an insulating layer of an insulated wire, it is preferable that the crosslinked silicone rubber is obtained by crosslinking the chain silicone rubber from the viewpoint of allowing extrusion molding to be easily performed.

The chain silicone rubber is constituted by siloxane units that each have one silicon atom and two side chains (organic groups). The peroxide crosslinking proceeds due to hydrocarbons being changed into radicals by dehydrogenation, and therefore, in this case, it is sufficient if the chain silicone rubber includes siloxane units having a hydrocarbon group in the side chain. Examples of the hydrocarbon group include an alkyl group and phenyl group. On the other hand, in the sulfur crosslinking or the hydrosilyl crosslinking, the chain silicone rubber needs to include siloxane units having an alkenyl group in the side chain. Examples of the alkenyl group include a vinyl group and a propenyl group. Although any crosslinking method may be performed on the chain silicone rubber, it is preferable to perform the peroxide crosslinking from the viewpoint of not requiring the introduction of the siloxane units having an alkenyl group into the side chain.

It is preferable that the chain silicone rubber includes, as a base unit, a dialkyl siloxane unit in which both the two side chains (organic groups) bonding to the one silicon are alkyl groups. The “base unit” refers to a unit whose content is at least 50 mol %. In this case, the base units may include only the same dialkyl siloxane units or different dialkyl siloxanle units. The former is preferable. The dialkyl siloxane unit can be represented by Formula (1) below.

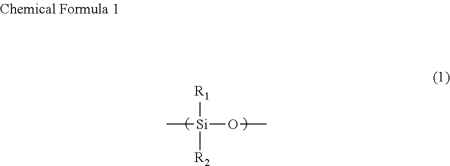

In Formula (1), R1 and R2 are alkyl groups. Examples of the alkyl groups include a methyl group, an ethyl group, and a propyl group. R1 and R2 may be the same alkyl group or different alkyl groups. It is preferable that R1 and R2 are the same alkyl group. It is more preferable that R1 and R2 are methyl groups.

Other than the dialkyl siloxane unit, the chain silicone rubber includes a siloxane unit having a phenyl group as an organo group. Accordingly, the heat resistance can be improved. Examples of the siloxane unit having a phenyl group include a siloxane unit having one phenyl group per siloxane unit (monophenyl siloxane unit) and a siloxane unit having two phenyl groups per siloxane unit (diphenyl siloxane unit). The chain silicone rubber may include only one of these siloxane units or both of these siloxane units. The diphenyl siloxane unit makes more contributions to the improvement of the heat resistance. The monophenyl siloxane unit makes a contribution to the improvement of the crosslinking speed.

The chain silicone rubber includes only one type of monophenyl siloxane units or different types of monophenyl siloxane units. The former is preferable. The monophenyl siloxane unit can be represented by Formula (2) below. In Formula (2), R3 is an alkyl group or an alkenyl group. Examples of the alkyl group include a methyl group, an ethyl group, or a propyl group. Examples of the alkenyl group include a vinyl group and a propenyl group. In Formula (2), R3 is preferably an alkyl group. The methyl group is preferable as the alkyl group.

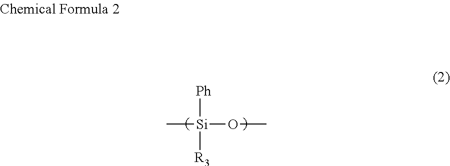

The diphenyl siloxane unit can be represented by Formula (3) below.

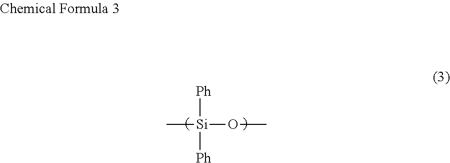

The content of the siloxane units having a phenyl group is at least 0.5 mol % from the viewpoint of improving the heat resistance. If the content of the siloxane units having a phenyl group is less than 0.5 mol %, the heat resistance required for the insulated wire cannot be satisfied. The content of the siloxane units having a phenyl group is preferably at least 5 mol %, more preferably at least 7 mol %, and still more preferably at least 10 mol %, from the viewpoint of obtaining a particularly good effect of improving the heat resistance.

On the other hand, the upper limit of the content of the siloxane units having a phenyl group is not particularly specified, but is preferably not more than 50 mol %, more preferably not more than 40 mol %, and still more preferably not more than 30 mol %, from the viewpoint of the delay of condensation polymerization due to steric hindrance, the delay of the peroxide crosslinking, and the like. It should be noted that the delay of the peroxide crosslinking can be reduced by increasing the blending amount of a peroxide crosslinking agent.

The chain silicone rubber may include only the dialkyl siloxane unit and the siloxane unit having a phenyl group or another siloxane unit in addition to these siloxane units. The former is preferable. Examples of another siloxane unit include siloxane units having an alkenyl group (but excluding siloxane units having an alkenyl group and a phenyl group). The chain silicone rubber may include only siloxane units having the same alkenyl group or siloxane units having different alkenyl groups. The former is preferable. Such a siloxane unit can be represented by Formula (4) below.

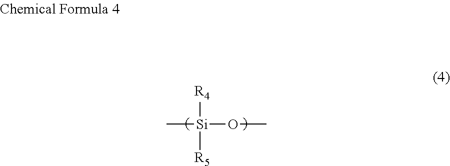

In Formula (4), R4 is an alkyl group or an alkenyl group, and R5 is an alkenyl group. R4 is preferably an alkyl group. Examples of the alkyl group include a methyl group, an ethyl group, and a propyl group. The methyl group is preferable. Examples of the alkenyl group include a vinyl group and a propenyl group. When R4 is an alkenyl group, R4 and R5 may be the same alkenyl group or different alkenyl groups.

A method using a solid state NMR can be used as a method for identifying the type of siloxane unit, such as the siloxane unit having an alkyl group, the siloxane unit having a phenyl group, and the siloxane unit having an alkenyl group, and quantifying the siloxane unit. The type and the content of the siloxane unit can also be determined from the blend ratio of organochlorosilane used as a material of the silicone rubber.

Examples of a crosslinking agent that can be used to crosslink the chain silicone rubber include a peroxide crosslinking agent and a hydrosilyl crosslinking agent.

Examples of the peroxide crosslinking agent include dialkyl peroxides such as dihexyl peroxide, dicumyl peroxide, t-butyl cumyl peroxide, and 2,5-dimethyl-2,5-bis(t-butylperoxy)hexane, and peroxyketals such as n-butyl 4, 4-di(t-butylperoxide)valerate.

Specific examples of the peroxide crosslinking agent include Perhexyl D, Percumyl D, Perhexa V Perbutyl D, Perbutyl C, and Perhexa 25B, which are manufactured by NOF Corporation.

An example of the hydrosilyl crosslinking agent is polyorganosiloxane having a hydrosilyl group. It is preferable that the polyorganosiloxane having a hydrosilyl group includes at least two hydrosilyl groups in one molecule. Hydrosilylation catalysts such as a platinum catalyst can be used in combination in the hydrosilyl crosslinking.

The blend amount of the crosslinking agent can be determined as appropriate. The blend amount of the crosslinking agent is preferably in a range of 0.01 to 10 parts by mass, more preferably in a range of 0.1 to 10 parts by mass, and still more preferably 0.5 to 7 parts by mass, with respect to 100 parts by mass of the total amount of uncrosslinked silicone rubber and silica.

As the uncrosslinked silicone rubber, a millable type (heat-crosslinking type), which forms an elastic body by being heated and crosslinked after being kneaded with a crosslinking agent, or a liquid rubber type, which is in a liquid form before being crosslinked, may be used. There are two types of the liquid rubber type silicone rubber: one is a room temperature crosslinking type (RTV), which can be crosslinked at near room temperature; and the other is a low temperature crosslinking type (LTV), which is crosslinked by being heated at near 100° C. after mixing.

The millable type silicone rubber is preferable as the uncrosslinked silicone rubber. Since the millable type silicone rubber is crosslinked at a relatively high temperature of 180° C. or higher and has a good stability, there is an advantage in that mixing is easily performed during kneading, and the workability is good. In contrast, since the liquid rubber type silicone rubber is commonly crosslinked at a low temperature of about 120° C. and has a low stability, it is necessary to suppress heat generation to a low level during kneading, and the workability is slightly worse from the viewpoint of temperature control and the like. A millable type silicone rubber that is commercially available as a rubber compound obtained by blending linear organopolysiloxane serving as a principal material (raw rubber) with a reinforcing agent, a filler (extending agent), a dispersion accelerator, other additives, and the like may be used.

In the present invention, the insulating layer may also contain at least one of the calcium carbonate powder, the magnesium oxide powder, and the magnesium hydroxide powder. In this case, the wear resistance can be improved. These powders are effective in improving the strength of the insulating layer containing the crosslinked silicone rubber. The wear resistance can be improved by improving the strength of the insulating layer.

That is, when these powders, which are more unlikely to be ground than the crosslinked silicone rubber, are blended, the strength of the insulating layer is improved, and thus the wear resistance is improved. It is inferred that in this case, the wear of the insulating layer is caused by these powders falling off from the insulating layer.

These powders are also effective in improving the gasoline resistance of the insulating layer containing the crosslinked silicone rubber. Silicone rubber is easily swelled when coming into contact with gasoline, and thus its gasoline resistance is poor, but these powders can be used to improve the gasoline resistance. It is inferred that this is because these powders suppress the infiltration of gasoline into the silicone rubber, and thus the swelling of the silicone rubber with gasoline is suppressed.

From the viewpoint of suppressing the reduction in cold resistance, and suppressing the reduction in heat resistance, for example, the content of these powders is preferably not more than 20 parts by mass, more preferably not more than 15 parts by mass, and still more preferably not more than 10 parts by mass, with respect to 100 parts by mass of the crosslinked silicone rubber. On the other hand, from the viewpoint of allowing the wear resistance and the gasoline resistance to be improved, for example, the content of these powders is preferably at least 0.1 parts by mass, more preferably at least 0.2 parts by mass, and still more preferably at least 0.5 parts by mass, with respect to 100 parts by mass of the crosslinked silicone rubber.

The average particle diameter of the calcium carbonate powder, the magnesium oxide powder, or the magnesium hydroxide powder is preferably at least 0.01 μm, and more preferably at least 0.05 μm, from the viewpoint of improving the handleability and reducing a time for mixing the powder into the silicone rubber, for example. Moreover, from the viewpoint of allowing cold resistance, wear resistance, and gasoline resistance to be easily made favorable, the average particle diameter of these powders is preferably not more than 5.0 μm, and more preferably not more than 4.0 μm. If the average particle diameter is small, the insulating layer has good surface smoothness, the powder is unlikely to fall off when frictional force is applied, and thus the wear resistance is improved. In addition, if the average particle diameter is small, the dispersibility is improved, and thus the wear resistance and the cold resistance are improved. It should be noted that the average particle diameter can be determined as a cumulative weight average value D₅₀ (or a median diameter) with a particle size distribution measurement apparatus using a laser beam diffraction method or the like.

From the viewpoint of suppressing aggregation and improving the affinity with silicone rubber, for example, a surface treatment may be performed on the calcium carbonate powder, the magnesium oxide powder, and the magnesium hydroxide powder. Examples of a surface treating agent include a homopolymer of α-olefin such as 1-heptene, 1-octene, 1-nonene, or 1-decene, a mutual copolymer thereof, a mixture thereof, fatty acid, rosin acid, and a silane coupling agent.

The above-mentioned surface treating agent may be modified. As a modifying agent, unsaturated carboxylic acid and a derivative thereof can be used. Specific examples of the unsaturated carboxylic acid include maleic acid and fumaric acid. Examples of the derivative of unsaturated carboxylic acid include maleic anhydride (MAH), maleic monoester, and maleic diester. Of these, maleic acid, maleic anhydride and the like are preferable. It should be noted that these modifying agents for a surface treating agent may be used alone or in a combination of two or more.

Examples of a method for introducing acid into a surface treating agent include a grafting method and a direct method. The acid-modified amount is 0.1 to 20 mass % of the surface treating agent, preferably 0.2 to 10 mass %, and more preferably 0.2 to 5 mass %.

There is no particular limitation on a surface treating method using a surface treating agent. The surface treatment may be performed on the above-mentioned powder or may be simultaneously performed during the synthesis of the above-mentioned powder. As the treating method, a wet treatment using a solvent or a dry treatment using no solvent may be performed. Aliphatic solvents such as pentane, hexane, and heptane, and aromatic solvents such as benzene, toluene, and xylene can be preferably used in the wet treatment. Moreover, when an insulating layer composition is prepared, the surface treating agent may be simultaneously kneaded with materials such as other raw materials of rubber.

There are two types of the calcium carbonate powder: one is synthetic calcium carbonate made through chemical reactions; and the other is heavy calcium carbonate made through the pulverization of limestone. The synthetic calcium carbonate on which the surface treatment using the surface treating agent such as fatty acid, rosin acid, and a silane coupling agent is performed can be used as fine particles having a primary particle diameter of submicrometer or less (about several tens of nanometers). The average particle diameter of the fine particles subjected to the surface treatment is expressed as a primary particle diameter. The primary particle diameter can be measured by electron microscopy. The heavy calcium carbonate is a pulverized product, and the surface treatment using fatty acid or the like is not necessarily performed thereon. The heavy calcium carbonate can be used as particles having an average particle diameter of several hundreds of nanometers to about 1 μm. Both the synthetic calcium carbonate and the heavy calcium carbonate can be used as the calcium carbonate powder.

Specific examples of the calcium carbonate powder include Hakuenka CC (average particle diameter=0.05 μm), Hakuenka CCR (average particle diameter=0.08 μm), Hakuenka DD (average particle diameter=0.05 μm), Vigot 10 (average particle diameter=0.10 μm), Vigot 15 (average particle diameter=0.15 μm), and Hakuenka U (average particle diameter=0.04 μm), which are manufactured by Shiraishi Calcium Kaisha, Ltd.

Specific examples of the magnesium oxide include UC95S (average particle diameter=3.1 μm), UC95M (average particle diameter=3.0 μm), and UC95H (average particle diameter=3.3 μm), which are manufactured by Ube Material Industries, Ltd.

As the magnesium hydroxide, synthetic magnesium hydroxide that is synthesized from sea water with a crystal growth method or synthesized through the reaction of magnesium chloride and calcium hydroxide, for example, natural magnesium hydroxide obtained through the pulverization of naturally occurring minerals, and the like can be used. Specific examples of the magnesium hydroxide serving as the above-mentioned filler include UD-650-1 (average particle diameter=3.5 μm) and UD653 (average particle diameter=3.5 μm), which are manufactured by Ube Material Industries, Ltd.

The insulating layer may or need not contain various additives as long as the characteristics of the insulating layer are not impaired. Examples of such additives include regular additives to be used in an insulating layer of an insulated wire. Specific examples thereof include a flame retardant, a filler, an antioxidant, an age resistor, and a pigment.

The insulated wire according to the present invention can be manufactured by forming an insulating layer around a conductor by extrusion molding. In this case, a rubber composition for an insulating layer that contains the uncrosslinked silicone rubber is prepared, and then the rubber composition is subjected to extrusion molding at a predetermined temperature. The uncrosslinked silicone rubber is crosslinked depending on the molding temperature and the molding time. After that, secondary vulcanization (secondary crosslinking) may be performed in order to complete the crosslinking of the silicone rubber. The secondary vulcanization is performed by heating with an oven, for example. The secondary vulcanization is performed for the purpose of not only completing the crosslinking of the silicone rubber but also thermally stabilizing the characteristics of the silicone rubber by providing a heat history to the silicone rubber, and removing residue produced in the peroxide crosslinking, for example.

The insulated wire according to the present invention can also be manufactured by coating a conductor with a rubber composition for an insulating layer to form a coating layer and by crosslinking uncrosslinked rubber in the coating layer using a crosslinking means such as heating.

The rubber composition for an insulating layer can be prepared by kneading the uncrosslinked silicone rubber and the silica with the calcium carbonate powder, the magnesium oxide powder, the magnesium hydroxide powder, the crosslinking agent, and the like, which are optionally blended. A common kneading machine such as a Banbury mixer, a pressurizing kneader, a kneading extruder, a twin-screw kneading extruder, or a roll can be used to knead the components of the rubber composition.

A wire extrusion molding machine used to manufacture common insulated wires can be used to subject the rubber composition for an insulating layer to the extrusion molding. As the conductor, a conductor used in common insulated wires can be used. Examples of the conductor include a single wire conductor and a twisted wire conductor that are made of a copper-based material or an aluminum-based material. The diameter of the conductor and the thickness of the insulating layer are not particularly limited and can be determined as appropriate depending on the application of the insulated wire.

Although the embodiment of the present invention has been described in detail, the present invention is not limited to the above-mentioned embodiment, and various modifications can be made without departing from the gist of the present invention. For example, although the insulated wire of the above-mentioned embodiment includes an insulating layer constituted by a single layer, the insulated wire according to the present invention may also include an insulating layer constituted by two or more layers.

The insulated wire according to the present invention can be used as an insulated wire to be used in automobiles and electric and electronic apparatuses.

### EXAMPLES

Hereinafter, examples and comparative examples of the present invention will be described.

### Synthesis of Silicone Rubber

Metal silicon was obtained by reducing silica rock with carbon. Dichlorodimethylsilane was obtained by reacting methyl chloride with the obtained metal silicon. Dichlorodiphenylsilane was obtained by reacting chlorobenzene with the obtained metal silicon. Dichloromethylphenylsilane was obtained by reacting chlorobenzene and methyl chloride with the obtained metal silicon.

Silicone rubber containing a phenylsilane group was obtained by mixing a predetermined amount of dichloromethylphenylsilane with dichlorodimethylsilane and subjecting this mixture to condensation polymerization.

Silicone rubber containing a diphenylsilane group was obtained by mixing a predetermined amount of dichlorodiphenylsilane with dichlorodimethylsilane and subjecting this mixture to condensation polymerization.

Silicone rubber containing a phenylsilane group and a diphenylsilane group was obtained by mixing a predetermined amount of dichloromethylphenylsilane and dichlorodip henylsilane with dichlorodimethylsilane and subjecting this mixture to condensation polymerization.

### Preparation of Silicone Rubber Composition

A silicone rubber composition for an insulating layer was prepared by mixing a predetermined amount of silica (“Nipsil HD2” having an average particle diameter of 3 μm manufactured by Tosoh Silica Corporation), a predetermined amount of a crosslinking agent (“Perhexyl D” (di-t-hexyl peroxide manufactured by NOF Corporation), and a predetermined amount of a filler (calcium carbonate powder “Vigot 15” (average particle diameter=0.15 μm) manufactured by Shiraishi Calcium Kaisha, Ltd.: only in Example 9) with the obtained silicone rubber.

### Production of Insulated Wire

The silicone rubber composition for an insulating layer was extruded using an extrusion molding machine to cover the outer circumference of a conductor (cross-sectional area of 0.5 mm²) constituted by an annealed copper stranded wire obtained by twisting seven annealed copper wires with a thickness of 0.2 mm (180° C.×5 minutes). Next, heat treatment was performed on the coating layer under a condition of 200° C.×4 hours to complete the crosslinking of the silicone rubber in the coating layer. Accordingly, insulated wires of Examples 1 to 9 and Comparative Examples 1 to 6 were obtained.

The insulated wires of Examples 1 to 9 and Comparative Examples 1 to 6 were subjected to a cold resistance test, a wear resistance test, and a heat resistance test, and evaluated. The results are collectively shown in Table 1 and Table 2. The test methods and the evaluations shown in Table 1 and Table 2 are as follows. It should be noted that in Table 1 and Table 2, the contents of silicone rubbers 1 to 13 and the silica in the silicone rubber compositions are expressed in mol % in terms of Si. Moreover, the contents of the crosslinking agent and the filler are expressed in part by mass with respect to 100 parts by mass of the total amount of the silicone rubber and the silica.

### Cold Resistance Test Method

The cold resistance test was performed in accordance with JIS C3005. Specifically, the produced insulated wire was cut to a length of 38 mm and used as a test piece. This test piece was attached to a cold resistance test machine, cooled to a predetermined temperature, and hit with a hitting tool. After that, the state of the test piece after hitting was observed. Five test pieces were used, and a temperature at which all of the five test pieces were broken was determined as a cold resistant temperature.

### Wear Resistance Test Method

The test was performed using a blade reciprocating method in accordance with the standard “JASO D618” of Society of Automotive Engineers of Japan. Specifically, the insulated wires of the examples and comparative examples were cut to a length of 750 mm and used as a test piece. A blade was reciprocated on the coating material (insulating layer) of the test piece in a length of at least 10 mm at a speed of 50 times per minute in the axial direction at room temperature of 23±5° C., and the number of reciprocations was counted until the blade reached the conductor. In this case, the load applied to the blade was set to 7 N. If the number of reciprocations was at least 200, the evaluation was “Good” (acceptable), and if the number of reciprocations was less than 200, the evaluation was “Poor” (not acceptable). If the number of reciprocations was at least 300, the evaluation was “Excellent”, which was particularly good.

### Heat Resistance Test Method

A cylindrical sample (length of 100 mm) constituted by the insulating layer obtained by removing the conductor from the insulated wire was used to measure the initial elongation and the elongation under the condition of 300° C.×3 days. If the retention of elongation was at least 30%, the evaluation was “Good” (acceptable). In the acceptable samples, if the retention of elongation was at least 50%, the evaluation was “Excellent”. If the retention of elongation was less than 30%, the evaluation was “Poor” (not acceptable).

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Silicone rubber 1 (mol %) | 60 | | | | | | | | |
| Silicone rubber 2 (mol %) | | 65 | | | | | | | |
| Silicone rubber 3 (mol %) | | | 70 | | | | | | |
| Silicone rubber 4 (mol %) | | | | 75 | | | | | 75 |
| Silicone rubber 5 (mol %) | | | | | 65 | | | | |
| Silicone rubber 6 (mol %) | | | | | | 70 | | | |
| Silicone rubber 7 (mol %) | | | | | | | 75 | | |
| Silicone rubber 8 (mol %) | | | | | | | | 75 | |
| Silica (mol %) | 40 | 35 | 30 | 25 | 35 | 30 | 25 | 25 | 25 |
| Vigot 15 | | | | | | | | | 5 |
| Crosslinking agent (Perhexyl D) | 3 | 2 | 2 | 2 | 2 | 3 | 5 | 5 | 2 |
| Content of phenylsilane group | 0.5 | | 1 | 0.5 | 5 | 10 | | 30 | 0.5 |
| (mol %) | | | | | | | | | |
| Content of diphenylsilane group | | 0.5 | | 0.5 | | | 20 | 20 | 0.5 |
| (mol %) | | | | | | | | | |
| Cold resistance (° C.) | −30 | −35 | −35 | −40 | −35 | −30 | −30 | −30 | −30 |
| Wearability | Excellent | Good | Good | Good | Good | Good | Good | Excellent | Excellent |
| Heat resistance | Good | Good | Good | Good | Excellent | Excellent | Excellent | Excellent | Good |

TABLE 2

| | Comp. | Comp. | Comp. | Comp. | Comp. | Comp. |
|---|---|---|---|---|---|---|
| | Ex. 1 | Ex. 2 | Ex. 3 | Ex. 4 | Ex. 5 | Ex. 6 |
| Silicone rubber 9 (mol %) | 50 | | | | | 50 |
| Silicone rubber 10 (mol %) | | 60 | | | | |
| Silicone rubber 11 (mol %) | | | 65 | | | |
| Silicone rubber 12 (mol %) | | | | 70 | | |
| Silicone rubber 13 (mol %) | | | | | 60 | |
| Silica (mol %) | 50 | 40 | 35 | 30 | 40 | 50 |
| Crosslinking agent (Perhexyl D) | 1 | 1 | 1 | 2 | 2 | 0.5 |
| Content of phenylsilane group | 0.2 | | 0.3 | | | 0.5 |
| (mol %) | | | | | | |
| Content of diphenylsilane group | | 0.3 | | 0.3 | 0.4 | |
| (mol %) | | | | | | |
| Cold resistance (° C.) | −30 | −30 | −35 | −35 | −30 | −30 |
| Wearability | Excellent | Excellent | Good | Good | Excellent | Excellent |
| Heat resistance | Poor | Poor | Poor | Poor | Poor | Poor |

It is found from the results of Examples 1 to 9 and Comparative Examples 1 to 6 that when the content of the silica with respect to the total amount of the crosslinked silicone rubber and the silica was not more than 40 mol %, and the content of the siloxane units having a phenyl group in the crosslinked silicone rubber was at least 0.5 mol %, good heat resistance could be obtained. It was confirmed that with the examples, good cold resistance and good wear resistance could also be obtained. It is also found from the results of Examples 5 to 8 that when the content of the siloxane units having a phenyl group in the crosslinked silicone rubber is at least 5 mol %, better heat resistance could be obtained. It is found from the results of Example 9 that when the calcium carbonate powder was added, the wear resistance was improved.

Although the embodiment of the present invention has been described in detail, the present invention is not limited to the above-mentioned embodiment, and various modifications can be made without departing from the gist of the present invention.

1. An insulated wire, wherein a conductor is covered with an insulating layer containing crosslinked silicone rubber and silica,
the crosslinked silicone rubber and being obtained by peroxide crosslinking,
the insulating layer containing the silica in an amount of not more than 40 mol % in terms of Si with respect to the total amount of the crosslinked silicone rubber and the silica,
the crosslinked silicone rubber containing, in an amount of at least 0.5 mol %, a siloxane unit having a phenyl group as an organo group.
